(19) United States
(12) Patent Application Publication
(10) Pub. No.: US 2011/0192284 A1
(43) Pub. Date: Aug. 11, 2011

(54) SPARK RESISTANT ION WIND FAN

(75) Inventors: Brian D. Sawyer, Palo Alto, CA (US); Scott L. Gooch, San Carlos, CA (US)

(73) Assignee: VENTIVA, INC., Santa Clara, CA (US)

(21) Appl. No.: 12/702,645

(22) Filed: Feb. 9, 2010

(51) Int. Cl. B03C 3/38; B03C 3/36

(52) U.S. Cl. 96/63

(57) ABSTRACT

The tendency of an ion wind fan to spark can be reduced by locating the emitter support portions of an isolator away from the active portions of the emitter and collector electrodes. In one embodiment, the present invention includes an ion wind fan having a first end, and a second end. The ion wind fan, in one embodiment, has a collector electrode, an emitter electrode, and an isolator supporting the collector electrode and the emitter electrode, the emitter electrode being supported by the isolator at an emitter support having an internal edge, where the distance from the internal edge of the emitter support end of the ion wind fan is less than the distance from the edge of the collector electrode end of the ion wind fan.

### FIELD OF INVENTION

The embodiments of the present invention relate to an ion wind fan, and particularly to sparking in an ion wind fan.

### BACKGROUND

It is well known that heat can be a problem in many electronics device environments, and that overheating can lead to failure of components such as integrated circuits (e.g. a central processing unit (CPU) of a computer) and other electronic components. Most electronics devices, from LED lighting to computers and entertainment devices, implements some form of thermal management to remove excess heat.

Heat sinks are a common passive tool used for thermal management. Heat sinks use conduction and convection to dissipate heat and thermally manage the heat-producing component. To increase the heat dissipation of a heat sink, a conventional rotary fan or blower fan has been used to move air across the surface of the heat sink, referred to generally as forced convection. Conventional fans have many disadvantages when used in consumer electronics products, such as noise, weight, size, and reliability caused by the failure of moving parts and bearings.

A solid-state fan using ionic wind to move air addresses the disadvantages of conventional fans. However, providing an ion wind fan that meets the requirements of consumer electronics devices presents numerous challenges not addressed by any currently existing ionic wind device. One such challenge faced by currently existing ion wind devices is sparking across electrodes. Sparks can damage electrodes and other electronic components, create a sharp audible noise, and can create electromagnetic interference (EMI).

### BRIEF DESCRIPTION OF THE DRAWINGS

FIG. 1 is a block diagram illustrating an ion wind fan implemented as part of thermal management of an electronic device;

FIG. 2A is a perspective view of an ion wind fan;

FIG. 2B is a widthwise cross-sectional view of the ion wind fan of FIG. 2A;

FIG. 2C is a top view of the ion wind fan of FIG. 2A

FIG. 2D is a magnification of a portion of FIG. 2C;

FIG. 3A is a perspective view of an ion wind fan according to one embodiment of the present invention;

FIG. 3B is a top view of the ion wind fan of FIG. 3A according to one embodiment of the present invention;

FIG. 3C is a magnification of a portion of FIG. 3B; and

FIG. 4 is a lengthwise cross-sectional view of an ion wind fan according to an embodiment of the present invention.

### DETAILED DESCRIPTION

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not necessarily be so limited; rather the principles thereof can be extended to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

Ion wind or corona wind generally refers to the gas flow that is established between two electrodes, one sharp and the other blunt, when a high voltage is applied between the electrodes. The air is partially ionized in the region of high electric field near the sharp electrode. The ions that are attracted to the more distant blunt electrode collide with neutral (uncharged) molecules en route to the collector electrode and create a pumping action resulting in air movement. The high voltage sharp electrode is generally referred to as the emitter electrode or corona electrode, and the grounded blunt electrode is generally referred to as the counter electrode or collector electrode.

The general concept of ion wind—also sometimes referred to as ionic wind and corona wind even though these concepts are not entirely synonymous—has been known for some time. For example, U.S. Pat. No. 4,210,847 to Shannon, et al., dated Jul. 1, 1980, titled “Electric Wind Generator” describes a corona wind device using a needle as the sharp corona electrode and a mesh screen as the blunt collector electrode. The concept of ion wind has been implemented in relatively large-scale air filtration devices, such as the Sharper Image Ionic Breeze.

### Example Ion Wind Fan Thermal Management Solution

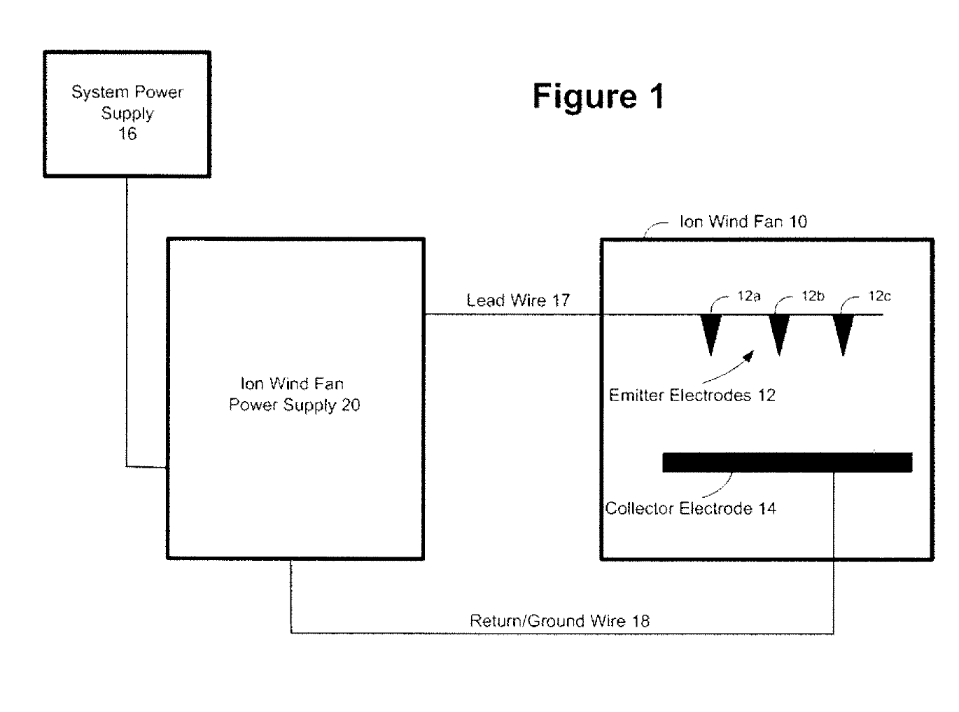

FIG. 1 illustrates an ion wind fan 10 used as part of a thermal management solution for an electronic device. As used in this Application, the descriptive term “ion wind fan,” is used to refer to any electro-aerodynamic pump, EHD pump, EHD thruster, corona wind device, ionic wind device, or any other such device used to move air or other gas. The term “fan” refers to any device that move air or some other gas. The term ion wind fan is meant to distinguish the fan from conventional rotary and blower fans. However, any type of ionic gas movement can be used in an ion wind fan, including, but not limited to corona discharge, dielectric barrier discharge, or any other ion generating technique.

An electronic device may need thermal management for an integrated circuit—such as a chip or a processor—that produces heat, or some other heat source, such as a light emitting diode (LED). Some example systems that can use an ion wind fan for thermal management include computers, laptops, gaming devices, projectors, television sets, set-top boxes, servers, NAS devices, memory devices, LED lighting devices, LED display devices, smart-phones, music players and other mobile devices, and generally any device having a heat source requiring thermal management.

The electronic device can have a system power supply 16 or can receive power directly from the mains AC via a wall outlet, Edison socket, or other outlet type. For example, in the case of a laptop computer, the laptop will have a system power supply such as a battery that provides electric power to the electronic components of the laptop. In the case of a wall-plug device such as a gaming device, television set, or LED lighting solution (lamp or bulb), the system power supply 16 will receive the 110V mains AC (in the U.S.A, 220V in the EU) current from an electrical outlet or socket.

The system power supply 16 for such a plug or screw-in device will also convert the mains AC into the appropriate voltage and type of current needed by the device (e.g., 20-50V DC for an LED lamp). While the system power supply 16 is shown as separate from the IWFPS 20, in some embodiments, one power supply can provide the appropriate voltage to both an ion wind fan 10 and other components of the electronic device. For example, a single driver can be design to drive the LEDs of and LED lamp and an ion wind fan included in the LED lamp.

The electronic device also includes a heat source (not shown), and may also include a passive thermal management element, such as a heat sink (also not shown). To assist in heat transfer, an ion wind fan 10 is provided in the system to help move air across the surface of the heat source or the heat sink, or just to generally circulate air (or some other gas) inside the device. In prior art systems, conventional rotary fans with rotating fan blades have been used for this purpose.

As discussed above, the ion wind fan 10 operates by creating a high electric field around one or more emitter electrodes 12 resulting in the generation of ions, which are then attracted to a collector electrode 14. In FIG. 1, the emitter electrodes 12 are represented as triangles as an illustration that they are generally “sharp” electrodes. However, in a real-world ion wind fan 10, the emitter electrodes 12 can be implemented as wires, shims, blades, pins, and numerous other geometries. Furthermore, while the ion wind fan 10 in FIG. 1 has three emitter electrodes (12a, 12b, 12c), the various embodiments of the present invention described herein can be implemented in conjunction with ion wind fans having any number of emitter electrodes 12.

Similarly, the collector electrode 14 is shown simply as a plate in FIG. 1. However, a real-world collector electrode 14 can have various shapes and will generally include openings to allow the passage of air. The collector electrode 14 can also be implemented as multiple collector electrodes (e.g., rods, washers) held at substantially the same potential. Since the specific emitter 12 and collector 14 geometries are not germane to the present invention, they are illustrated as triangles and plates for simplicity and ease of understanding. Furthermore, in a real world ion wind fan 10, the emitter electrodes 12 and the collector electrode 14 would be disposed on a dielectric chassis—sometimes referred to as an isolator element—that has also been omitted from FIG. 1 for simplicity and ease of understanding.

To create the high electric field necessary for ion generation, the ion wind fan 10 is connected to an ion wind power supply 20. The ion wind power supply 20 is a high-voltage power supply that can apply a high voltage potential across the emitter electrodes 12 and the collector electrode 14. The ion wind fan power supply 20 (hereinafter sometimes referred to as “IWFPS”) is electrically coupled to and receives electrical power from the system power supply 16. Usually for electronic devices, the system power supply 16 provides low-voltage direct current (DC) power. For example, a laptop computer system power supply would likely output approximately 5-12V DC, while the power supply for an LED light fixture would likely output approximately 20-70V DC.

The high voltage DC generated by the IWFPS 20 is then electrically coupled to the emitter electrodes 12 of the ion wind fan 10 via a lead wire 17. The collector electrode 14 is connected back to the IWFPS 20 via return/ground wire 18, to ground the collector electrode 14 thereby creating a high voltage potential across the emitters 12 and the collector 14 electrodes. The return wire 18 can be connected to a system, local, or absolute high-voltage ground using conventional techniques.

While the system shown in and described with reference to FIG. 1 uses a positive DC voltage to generate ions, ion wind can be created using AC voltage, or by connecting the emitters 12 to the negative terminal of the IWFPS 20 resulting in a “negative” corona wind. Embodiments of the present invention are not limited to positive DC voltage ion wind. Furthermore, while the IWFPS 20 is shown to receive power from a system power supply 30, in other embodiment, the IWFPS 20 can receive power directly from an outlet.

The IWFPS 20 may include other components. Furthermore, in some embodiments, some of the components listed above may be omitted or replaced by similar or equivalent circuits. For example, the IWFPS 20 is described only as an example. Many different kinds and types of power supplies can be used as the IWFPS 20, including power supplies that do not have a transformers or other components shown in FIG. 1. The components described need not be physically separate, and may be combined on a single printed circuit board (PCB).

### Sparking or Arcing in an Ion Wind Fan

As described partially above, ion wind is generated by applying a high voltage potential across the emitter 12 and collector 14 electrodes. Below some onset voltage that is specific to the electrode geometry and dependent on the air gap between the emitter electrodes 12 and the collector electrode 14 no ions are generated and ion wind is not created. Furthermore, above some breakdown voltage threshold that exceeds the dielectric breakdown voltage of the gas gap separating an emitter electrode 12 from the collector 14, a spark—i.e. short circuit—is created between the emitter electrode 12 and the collector electrode 14.

Thus, the operating voltage range of an ion wind fan 10 is dependent, inter glia, on the air gap between the emitter electrodes 12 and the collector electrode 14. While prior art air filtration systems using ion wind have been relatively large scale, an ion wind fan 10 designed to be part of a thermal management solution of an electronic device will generally be small scale. Such ion wind fans are in the approximate range of 20×3×2 mm up to 100×22×12 mm in size, although the present invention is not limited to ion wind fans in any particular size range.

Thus, the operating range of the of the ion wind fan 10 will be relatively narrow. For example, one tested ion wind fan has an operating range approximately 3.5-5.5 kV. At such narrow tolerances, changes in the air gap—such as a temporary increase of dust in the air—as well as changes in the electrodes over time, can result in sparking. Furthermore, it is generally desirable to operate ion wind fans as close to the breakdown voltage as possible for maximum ion generation. This further decreases the desirable operation range of an ion wind fan 10.

Sparks have several undesirable side effects. Since the electrodes of the ion wind fan 10 can be small and fragile, sparks can damage the electrodes over time. Sparks are also accompanied by an audible noise, a miniature version of thunder that accompanies lightning. Such noise is undesirable in consumer electronics devices and other devices utilizing thermal management. Also, sparks create electromagnetic interference (EMI) that can interfere with the functioning of nearby electronic component, such as the other electronic circuitry of a consumer electronics device.

The general problem of sparking in an ionic wind device has been known for some time. For example, U.S. Pat. No. 6,937,455 to Krichtafovich et al. entitled SPARK MANAGEMENT METHOD AND DEVICE (“the '455 patent”) describes a purported process for monitoring for a “pre-spark signature” and upon detecting such signature, reducing the operating voltage of an ion wind fan. Whether the circuit described in the '455 patent is capable of actually managing sparks is not discussed in this Application, but the problem of sparking or arcing in an ion wind fan remains a challenge for ionic wind devices.

### Isolator Edge Sparking

As described partially above, ion wind is generated by the ion wind fan 10 by applying a high voltage potential across the emitter 12 and collector 14 electrodes. This creates a strong electric field around the emitter electrodes 12, strong enough to ionize the air in the vicinity of the emitter electrodes 12, in effect creating a plasma region. The ions are attracted to collector electrode 12, and as they move in air gap along the electric field lines, the ions bump into neutral air molecules, creating airflow. On a real world collector electrode 14, air passage openings (not shown) allow the airflow to pass through the collector 14 thus creating an ion wind fan.

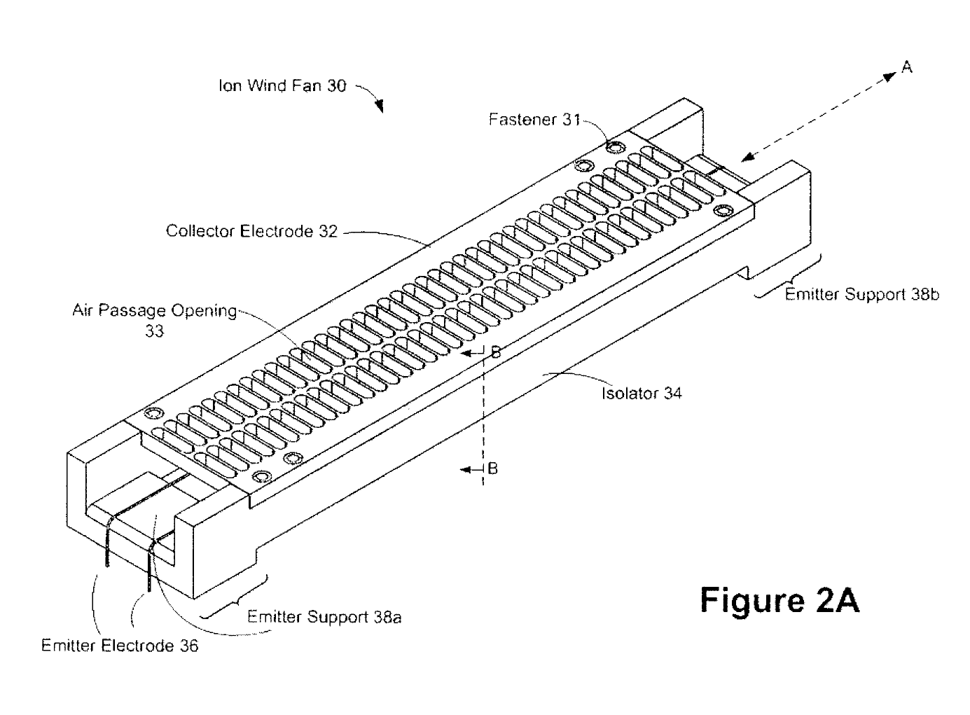

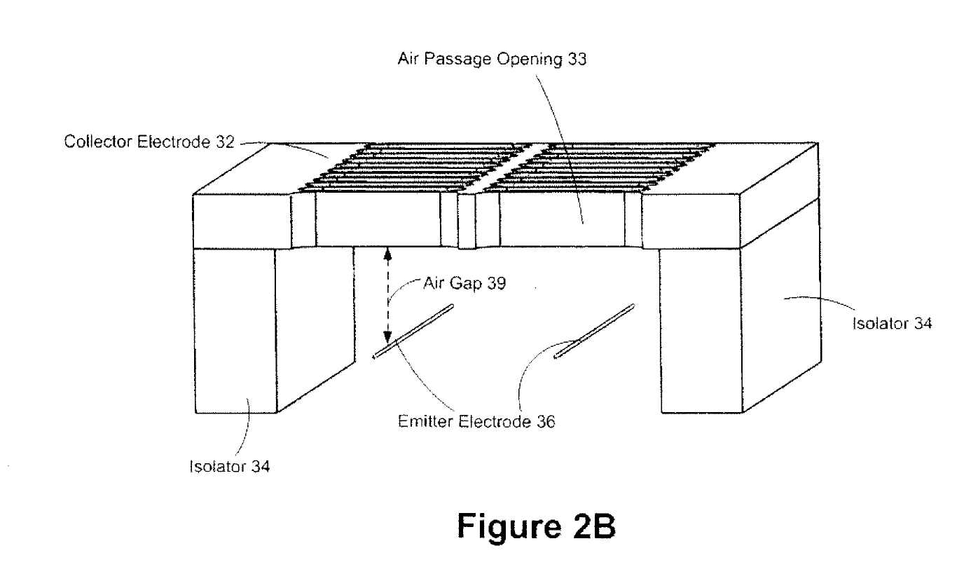

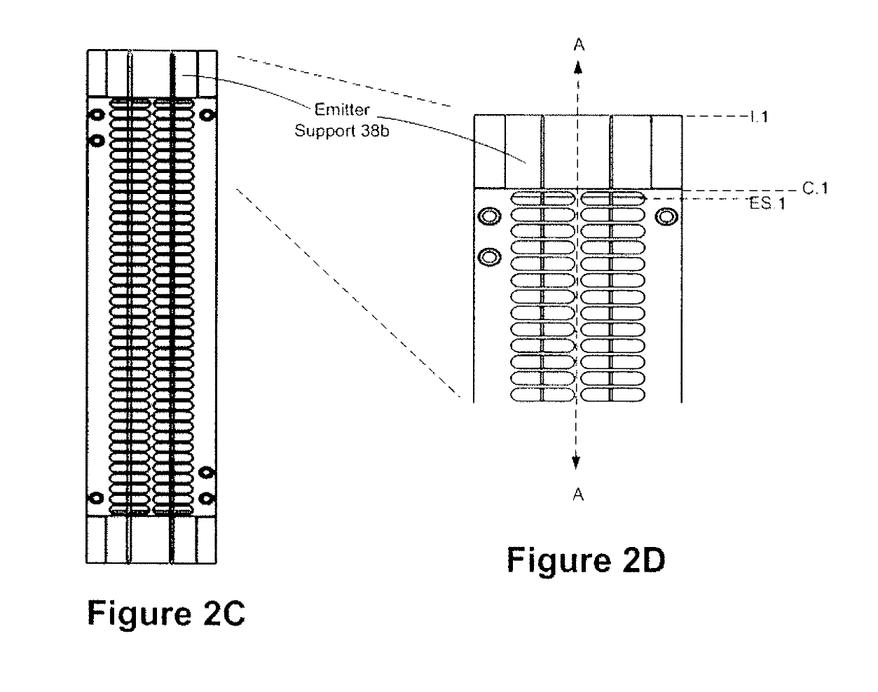

An example of such an ion wind fan is now described with reference to FIG. 2A. FIG. 2A is a perspective view of an example ion wind fan 30. The ion wind fan 30 includes a collector electrode 32 having air passage openings 33 to allow airflow. This example ion wind fan 30 has two emitter electrodes 36 implemented as wires, thus implementing what is sometimes referred to as a “wire-to-plane” configuration.

The collector electrode 32 and the emitter electrodes 36 are both supported by an isolator 34. The isolator is made of a dielectric material, such as plastic. The “isolator” component is thusly named as it functions to electrically isolate the emitter electrodes 36 from the collector electrode 32, and to physically support these electrodes and establish the spatial relationship between the electrodes. The isolator 34 can be made from one integral piece—as shown in FIG. 2A—or it can be made of multiple parts and pieces.

In the embodiment shown in FIG. 2A, the collector electrode is attached to the isolator using a fastener 31. The fastener 31 in FIG. 2 is a stake, but any other attachment method can be used, including but not limited to screws, hooks, glue, and so on. Similarly, the particular method of attachment of the emitter electrodes 36 is not essential to the embodiments of the present invention. The emitter electrodes 36 can be glued, staked, screwed, tied, held by friction, or attached in any other way to the isolator 34.

The ion wind fan 30—in the embodiment shown in FIG. 2A—is substantially rectangular in top view. The longitudinal axis of the ion wind fan 30 is denoted with the dotted arrow labeled “A.” The ion wind fan 30 has two ends opposite each other along the longitudinal axis. The emitter electrodes 36 are suspended between the two ends of the ion wind fan 30.

In one embodiment, the emitter electrodes 36 are supported at the ends of the ion wind fan 30 by an emitter support 38 portion of the isolator. The emitter support 38a at the left end of the ion wind fan 30 is most visible in FIG. 2A. The emitter support 38a is a portion of the isolator that physically supports the emitter electrodes 36. In one embodiment, the emitter electrodes 36 are suspended (in tension) between the two emitter supports 38 at the two ends of the ion wind fan 30.

In one embodiment, the emitter support 38a is a substantially rectangular solid portion of the isolator 34 that connects the two elongated side portions of the isolator 34. However, the emitter supports 38 can have many other shapes. For example, a part of the center portion of the emitter support 38a between the emitter electrodes 36 could be cut away without substantially affecting the function of the emitter support 38a.

The emitter support 38a is shown as extending to the end of the ion wind fan 30. However, in other embodiments, the emitter support 38a can end before the end of the ion wind fan 30. The emitter support 38a is also shown as having a curved section at its outside edge to smooth out the 90 degree bend in the wire emitter electrodes 36. This is an optional feature not related to the embodiments of the present invention described herein.

Indeed, the actual attachment of the emitter electrodes 36 to either the emitter support 38 or some other portion of the isolator 34 is not material to the embodiments of the present invention, and therefore will not be discussed in much detail for simplicity and ease of understanding. The emitter electrodes 36 are shown as extending downward from the left end of the ion wind fan 30 and they are connected to the power supply via some wire or bus, as is the collector electrode 32. The emitter supports 38 need not have any particular shape of contact with the emitter electrodes 36. The emitter supports 38 are the portions of the isolator 34 that define the physical spatial relationship between the emitter electrodes 34 and other components of the ion wind fan 30. How exactly the emitter supports 38 are in contact with the emitter electrodes 36 (grooves, stakes, friction, posts) are not germane to the embodiments of the present invention.

FIG. 2B further illustrates the example ion wind fan 30 shown in FIG. 2A. FIG. 2B is a perspective cross sectional view of the ion wind fan 30 along the line B-B shown in FIG. 2A. The emitter electrodes 36 are suspended in air, and held a substantially constant air gap 39 distance away from the collector electrode 32.

Though wire sag and other emitter irregularities will create some variance, in one embodiment the air gap 39 between the emitter electrodes 36 and the bottom plane of the collector electrode 32 is substantially constant (within a 5% variation). In other embodiments, the air gap 39 can be more variable. The size of the air gap 39 is dependent on the spatial relationship between the electrodes established by the emitter supports 38 (which are not visible in FIG. 2B).

FIGS. 2C and 2D are top views of the ion wind fan 30 shown in and described with reference to FIG. 2A. FIG. 2D is a magnification of to right side end of the ion wind fan 30 along its longitudinal axis (A). Dotted lines illustrate three edge measurements along the longitudinal axis. I.1 represents the edge of the isolator 34 and the effective end of the ion wind fan 30; C.1 represents the edge of the collector electrode 32; and ES.1 represents the inside edge of the emitter support 38b. The inside edge of the emitter support is the edge that faces the opposite end of the ion wind fan 30.

As can be seen in FIG. 2D, the inside edge (ES.1) of the emitter support 38b overlaps the active surface of the collector electrode 32. Stated another way, the distance between ES.1 (the inside edge of the emitter support) and I.1 (the end of the ion wind fan) is greater than the distance between C.1 (the collector edge) and I.1. By performing various spark experiments and analyzing the damage caused by sparking to the emitter electrodes 36, the collector electrode 32, and the isolator 34, the inventors of the present invention have determined that sparks were more likely to happen along the portion of the emitter electrodes 36 that are supported by the emitter support. The introduction of the dielectric material that the emitter support 38 is made of into the electric field around the emitter electrodes 36 creates disruptions in the electric field causing an increased likelihood of sparking at the region around the inside edge (ES.1) of the isolator support 38b.

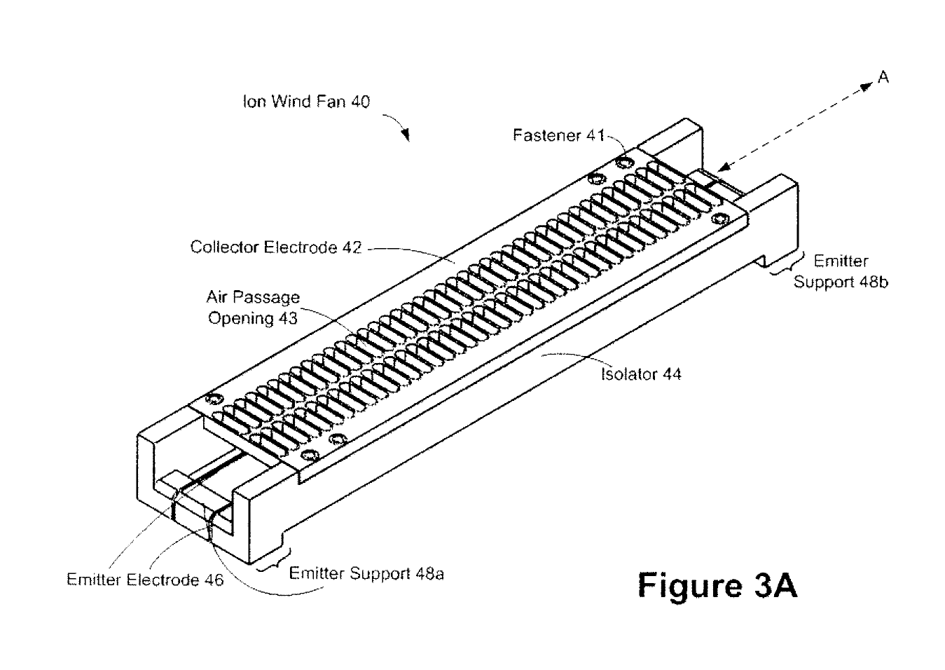

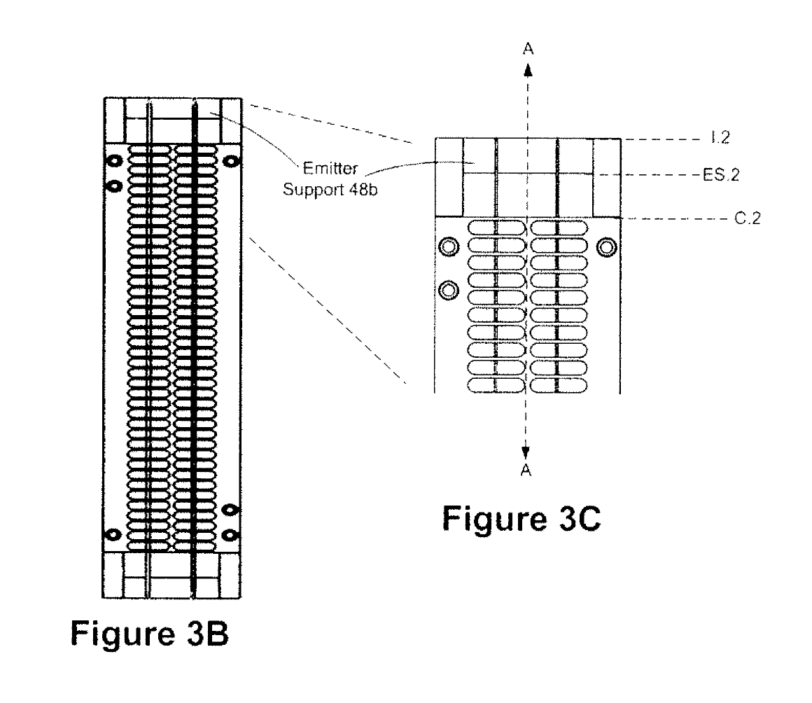

Several embodiments of an improvement to the ion wind fan 30 shown in FIG. 2A-D are now described with reference to FIGS. 3A-C. FIG. 3A is a perspective view of an ion wind fan 40. Many of the components and elements described with reference to FIGS. 2A-B are similar or identical to those described above, and they are not described again for simplicity and ease of understanding. Instead, the description of FIGS. 3A-C focus on the differences between the ion wind fan 30 shown in FIG. 2A and the ion wind fan 40 shown in FIG. 3A.

As can be seen in FIG. 3A, the emitter support 48a at the left end of the ion wind fan 40 along the longitudinal axis is shorter than the emitter support 38a shown in FIG. 2A. In all other aspects, the emitter support 48a can be similar to emitter support 38a. By shortening the emitter support 48a, the inside edge of the emitter support 38a can be moved further away from the edge of the collector electrode 42 along the longitudinal axis. Emitter support 48b can be similarly shortened.

According to another embodiment, the size and width of the emitter support 48 need not change. Instead, the isolator 44 can be elongated so that the ends of the ion wind fan 40—and thus the inside edge of the emitter support 48—are relocated further from the edge of the collector electrode 42 along the longitudinal axis. In yet another embodiment, the length of the collector 42 can be shorter than the length of the collector 32 in the direction of the longitudinal axis to achieve the same desired result.

By moving the dielectric emitter support 48 away from the area directly under the collector electrode 42, the sparking to the portion of the emitter electrodes 46 that is supported by the emitter support 48 is greatly reduced, and can even be completely eliminated. FIGS. 3B and 3C show a top view of the ion wind fan 40, and further illustrate the example embodiment of the present invention. In FIGS. 3B-C, the quantities I.2 (ion wind fan edge), ES.2 (emitter support inside edge), and C.2 (collector electrode edge) have substantially the same meanings as the corresponding X.1 values discussed with reference to FIG. 2C-D.

As can be seen in FIG. 3C, in one embodiment of the present invention, the inside edge of the emitter support 48b is no longer under the collector electrode 42. Stated another way, the distance between ES.2 (the inside edge of the emitter support) and I21 (the end of the ion wind fan) is now less than the distance between C.2 (the collector edge) and I.2. In other words ES.2 is further towards the end of the ion wind fan 40 than C.2 along the longitudinal axis.

How far the inside edge of the emitter support 48 is from the edge of the collector electrode 42 along the longitudinal axis (i.e., the distance between ES.2 and C.2) to have the desired effect is a function of the air gap 39 of the ion wind fan 40 and the available overhead space on the ion wind fan 40. Various other limitations, such as the structural rigidity of the isolator 44 can also be a factor when calculating the emitter support offset. The “emitter support offset” refers to the distance between ES.2 and C.2 along the longitudinal axis.

In one embodiment, the emitter support offset is designed to be at least one half as long as the air gap 39. In other words, the edge of the emitter support 48 is at least half as far away from the edge of the collector electrode 42 along the longitudinal axis as the emitter electrodes 46 are from the collector electrode 42 along an axis perpendicular to the longitudinal axis. In another embodiment, the minimum emitter support offset is only one third or the air gap 39. In yet another embodiment, the emitter support offset is at least two thirds of the air gap 39. In yet another embodiment, the minimum emitter support offset is equal to the air gap 39.

Other factors can influence the emitter support offset in addition to the air gap. For example, the power (wattage), the voltage, and the current that the ion wind fan 40 is operating at can affect the emitter support offset. In one embodiment, the emitter support offset is selected to account for the maximum power, voltage, and current values to which the ion wind fan 40 will be exposed.

In the descriptions referencing FIGS. 3A-C, the emitter support offset has been described in terms of distance along a longitudinal axis. It has been assumed that the edge of the isolator (I.2), the edge of the collector (C.2), and the inside edge of the emitter support (ES.2) are well defined. Indeed, when these edges are substantially straight, they are straightforward to define. When these edges are not straight, they can be defined as being perpendicular to the longitudinal axis at substantially the farthest point along the longitudinal axis. For I.2 this point would be the very end of the ion wind fan 40; for ES.2 this point would be the most inside point along the inside edge of the emitter support 48; and for C.2 this point would be the point facing the emitter electrodes 46 that is closet to the end of the ion wind fan along the longitudinal axis. Various other definitions are possible.

In another embodiment, however, the emitter support offset is defined in terms of location with respect to the plasma that surrounds the emitter electrodes 46. When the ion wind fan 40 is on and generating ionic wind, the emitter electrodes 46 are surrounded by a cylindrical region of plasma around the emitter wires. In the case of non-wire emitters, there is still a plasma region around the sharp edge or point of the emitter electrodes. In the case of wire emitter electrodes, the plasma region extends perpendicularly away from the length of the wire approximately as far as the diameter of the wire. In one embodiment the diameter of the emitter wire is about 50 microns, but both thinner and thicker wires can be utilized. The thickness of the emitter wires and the depth of the plasma region are not germane to the embodiments of the present invention, and is discussed only for general understanding of ion wind fans.

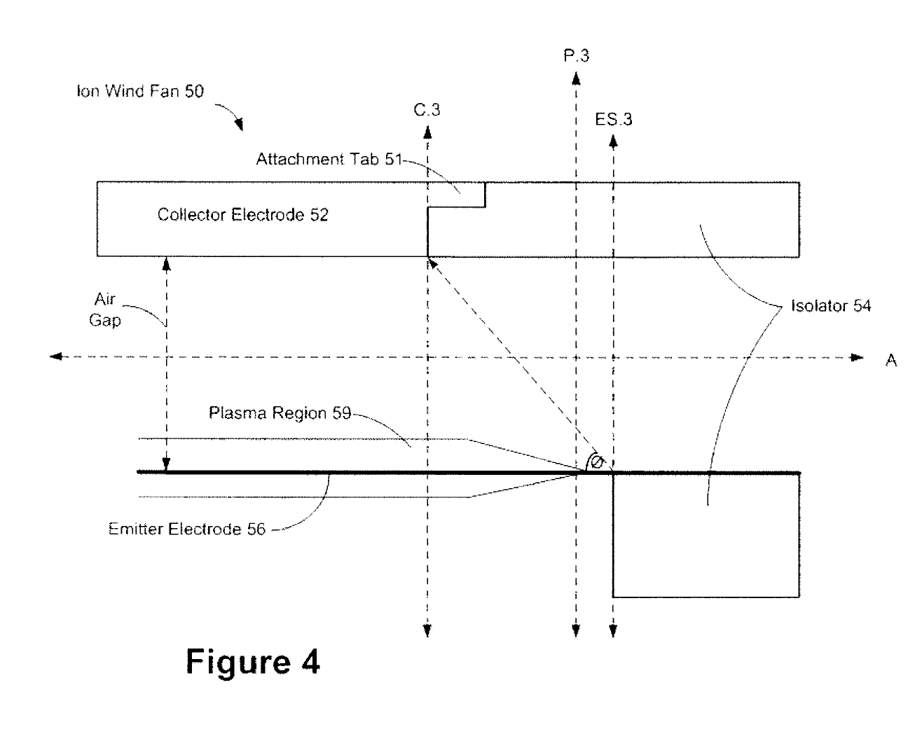

One embodiment of an ion wind fan 50 having an emitter electrode 56 generating a plasma region 59 is now described with reference to FIG. 4. FIG. 4 is a cross-sectional view of the ion wind fan 50 along the longitudinal axis (A). The emitter electrode 56 is again a wire electrode, as in FIGS. 3A-C. The edge measurements—C.3 for the collector edge, and ES.3 for the emitter support edge—are similar to the edge measurements described with reference to FIGS. 2 and 3. The edge measurement P represents the edge of the plasma region 59.

The edge of the plasma region (P) can be defined as the point along the emitter electrode 56 where plasma 59 ceases to surround the emitter electrode 56. However, such a point may not be consistent and clearly defined. Thus, according to another definition, the edge of the plasma region (P) is defined as any point along the emitter electrode 56 where the depth of the plasma region is less then half of the plasma region along the active portion of the emitter electrode 56.

The active portion of the emitter electrode 56 is the portion of the emitter electrode 56 that is directly under the collector electrode. As illustrated in FIG. 4, after the edge of the collector electrode (C.3) the plasma region 59 starts to decrease in depth and intensity along the length of the emitter electrode 56 toward to emitter support edge. Another concept illustrated by FIG. 4, is that—in one embodiment—the edge of the collector electrode C.3 is defined by the side of the collector electrode 52 that faces the emitter electrode 56. Thus, for example, the attachment tab 51 shown in FIG. 4 would not be counted when determining the edge of the collector electrode (C.3)

Therefore, according to one embodiment of the present invention, the inside edge of the emitter support (ES.3) is outside of the plasma region 59, where the plasma region 59 ends at edge, and P is defined according to one of the various definitions set forth above. Such an embodiment of the present invention does not rely on distances to define the relationships between the various components. Once the edge of the plasma region 59 is defined, according to such an embodiment, the emitter support 58 must be located outside of the plasma region 59.

According to yet another embodiment, the relationship between the components can be defined by the angle (represented by Ø in FIG. 4) between the emitter electrode and the edge of the collector electrode 52 (C.3—along the bottom plane of the collector electrode 52, as shown in FIG. 4). In one embodiment, the angle Ø must be less than 70 degrees. In another embodiment, the angle Ø is between 65 and 45 degrees.

In the descriptions and Figures above, the emitter electrodes have been represented by wire electrodes. However, other embodiments of the present invention can use different emitter geometries, such as shim emitters, bar emitters, pin emitters, and other such emitter electrodes. Furthermore, pairs of emitter electrodes can be provided together to generate dielectric barrier discharge. The embodiments of the present invention are not limited to any particular type of emitter electrode or discharge phenomena.

Furthermore, the example ion wind fans described and pictured above are shown as having two emitter electrodes. However, any number of emitter electrodes can be used, including one. While most electronics cooling applications using a wire emitter will have between 1-10 emitter electrodes, the invention is not limited to any range of emitter electrodes used.

Figures such as FIG. 3C and FIG. 4 and the accompanying descriptions focus on one end of the ion wind fan for simplicity and ease of understanding. The second end of the ion wind fan can implement any embodiment of the invention in substantially the same manner as the example embodiments discussed and illustrated. The two ends—and two emitter supports—of the ion wind fan can implement different embodiments of the present invention. Furthermore, some ion wind fans will only implement an embodiment of the present invention at one end and emitter support, but not the opposing end. Yet other embodiments of the present invention can be implemented in ion wind fans having more than two ends.

In the descriptions above, various functional modules are given descriptive names, such as “ion wind fan power supply.” The functionality of these modules can be implemented in software, firmware, hardware, or a combination of the above. None of the specific modules or terms—including “power supply” or “ion wind fan”—imply or describe a physical enclosure or separation of the module or component from other system components.

Furthermore, descriptive names such as “emitter electrode,” “collector electrode,” and “isolator,” are merely descriptive and can be implemented in a variety of ways. For example, the “collector electrode,” can be a plate-like component with oval air-passage openings (as shown in the Figures), but it can also be made of multiple rods spaced apart, a mesh screen, or in numerous other geometries. The embodiments of the present invention are not limited to any particular kind of collector electrode.

Similarly, the isolator can be the substantially frame-like component shown in the Figures, but it can have various shapes. The electrodes and the isolator are not limited to any particular material; however, the isolator will generally be made of a dielectric material.

What is claimed:

1. An ion wind fan having a longitudinal axis, a first end, and a second end longitudinally opposite to the first end, the ion wind fan comprising:
a collector electrode having a first edge and a second edge longitudinally opposite to the first edge;
an emitter electrode oriented in the longitudinal direction; and
an isolator supporting the collector electrode and the emitter electrode, the emitter electrode being supported by the isolator at a first emitter support having an internal edge, wherein the distance in the direction of the longitudinal axis from the internal edge of the first emitter support to the first end of the ion wind fan is less than the distance in the direction of the longitudinal axis from the first edge of the collector electrode to the first end of the ion wind fan.

2. The ion wind fan of claim 1, wherein the isolator supports the collector electrode and the emitter electrode so that there is a substantially constant air gap between the collector electrode and the emitter electrode.

3. The ion wind fan of claim 2, wherein the difference between the distance from the first edge of the collector electrode to the first end of the ion wind fan in the direction of the longitudinal axis and the distance from the internal edge of the first emitter support to the first end of the ion wind fan in the direction of the longitudinal axis is approximately one half of the air gap between the collector electrode and the emitter electrode.

4. The ion wind fan of claim 2, wherein the difference between the distance from the first edge of the collector electrode to the first end of the ion wind fan in the direction of the longitudinal axis and the distance from the internal edge of the first emitter support to the first end of the ion wind fan in the direction of the longitudinal axis is at least one fourth of the air gap between the collector electrode and the emitter electrode.

5. The ion wind fan of claim 2, wherein the difference between the distance from the first edge of the collector electrode to the first end of the ion wind fan in the direction of the longitudinal axis and the distance from the internal edge of the first emitter support to the first end of the ion wind fan in the direction of the longitudinal axis is approximately the same as the air gap between the collector electrode and the emitter electrode.

6. The ion wind fan of claim 1, wherein an angle between the internal edge of the first emitter support and the first edge of the collector electrode is approximately 45 degrees.

7. The ion wind fan of claim 1, wherein an angle between the internal edge of the first emitter support and the first edge of the collector electrode is less than 70 degrees.

8. The ion wind fan of claim 1, wherein the emitter electrode is further attached to the isolator at a second emitter support having an internal edge, wherein the distance from the internal edge of the second emitter support to the second end of the ion wind fan in the direction of the longitudinal axis is less than the distance from the second edge of the collector electrode to the second end of the ion wind fan in the direction of the longitudinal axis.

9. An ion wind fan having a longitudinal axis, a first end, and a second end longitudinally opposite to the first end, the ion wind fan comprising:
an isolator comprising a dielectric material, the isolator having a first emitter support and a second emitter support;
an emitter electrode having a first end and a second end, wherein the first end of the emitter electrode is attached to the isolator at the first emitter support and the second end of the emitter electrode is attached to the isolator at the second emitter support; and
a collector electrode attached to the isolator;
wherein applying a high voltage potential across the emitter electrode and the collector electrode generates a plasma region around at least a portion of the emitter electrode, and wherein the first emitter support is outside of the plasma region.

10. The ion wind fan of claim 9, wherein the isolator has a first end, and a second end longitudinally opposite to the first end, wherein the first emitter support is located at or around the first end of the isolator and the second emitter support is located at or around the second end of the isolator.

11. The ion wind fan of claim 10, wherein the isolator comprises a first longitudinal member oriented in the direction of the longitudinal axis, and a second longitudinal member oriented in the direction of the longitudinal axis, and wherein the first isolator support connects the first longitudinal member to the second longitudinal member.

12. The ion wind fan of claim 9, wherein the isolator is integrally formed.

13. An ion wind fan having a longitudinal axis, the ion wind fan comprising:
a collector electrode having a first edge and a second edge longitudinally opposite to the first edge;
an emitter electrode oriented in the longitudinal direction; and
an isolator supporting the emitter electrode and the collector electrode so that there is an air gap separating the emitter electrode and the collector electrode, the isolator including an emitter support, the emitter support being offset from the first edge of the collector electrode in the direction of the longitudinal axis by an offset distance.

14. The ion wind fan of claim 13, wherein the air gap is substantially constant along the length of the emitter electrode.

15. The ion wind fan of claim 14, wherein the offset distance is at least half as long as the air gap.

16. The ion wind fan of claim 14, wherein the offset distance is at least one third as long as the air gap.

17. The ion wind fan of claim 13, wherein the offset distance is dependent on both the maximum air gap and the maximum operating power of the ion wind fan.

18. An ion wind fan comprising:
an emitter electrode at least partially surrounded by a plasma region along a portion of the length of the emitter electrode when the ion wind fan is operational; and
an emitter support to which the emitter electrode is attached, the emitter electrode being attached to the emitter support at a portion that is outside the plasma region.

19. The ion wind fan of claim 18, wherein a portion of the emitter electrode is outside of the plasma region if any plasma in the vicinity of the portion of the emitter electrode has a thickness that is less than half of the average thickness of the plasma region.
